(19) United States
(12) Patent Application Publication
(10) Pub. No.: US 2016/0115864 A1
(43) Pub. Date: Apr. 28, 2016

(54) CONFORMAL SURFACE HEAT EXCHANGER FOR AIRCRAFT

(71) Applicant: UNISON INDUSTRIES, LLC, Jacksonville, FL (US)

(72) Inventors: Keith Alan CAMPBELL, Liberty Township, OH (US); Michael Ralph STORAGE, Beavercreek, OH (US); Dennis Alan MCQUEEN, Miamisburg, OH (US); Bradley MOTTIER, Cincinnati, OH (US)

(21) Appl. No.: 14/895,638

(22) PCT Filed: Jun. 3, 2014
(86) PCT No.: PCT/US2014/040723

§ 371 Date: Dec. 3, 2015

Related U.S. Application Data
(60) Provisional application No. 61/830,434, filed on Jun. 3, 2013.

(51) Int. Cl. F02C 3/10; F02C 7/18; B64D 33/08

(52) U.S. Cl. CPC F02C 3/10; B64D 33/08; F02C 7/18; F05D 2220/32

(57) ABSTRACT

A heat exchanger is described which conforms to external surface contours of an aircraft, such as an airplane or a helicopter, having a turbo-prop assembly. The heat exchanger is provided to cool engine fluids, which rise in temperature during engine operation.

### BACKGROUND

The present embodiments generally pertain to heat exchangers utilized with gas turbine turbo-prop engines. More particularly, the present embodiments relate to surface conforming heat exchanger for an aircraft which utilize airflow from a turbo-prop to provide liquid-to-air heat exchange for engine fluid cooling.

In a gas turbine engine, air is pressurized in a compressor and mixed with fuel in a combustor for generating hot combustion gases which flow downstream through turbine stages. A typical gas turbine engine generally possesses a forward end and an aft end with its several core or propulsion components positioned axially therebetween. An air inlet or intake is located at a forward end of the engine. Moving toward the aft end, in order, the intake is followed by a compressor, a combustion chamber, and a turbine. It will be readily apparent from those skilled in the art that additional components may also be included in the engine, such as, for example, low-pressure and high-pressure compressors, and low-pressure and high-pressure turbines. This, however, is not an exhaustive list. In a typical turbo-prop gas turbine engine aircraft, turbine stages extract energy from the combustion gases to turn a turbo-propeller. In some embodiments, the propulsor may power one or more turbo-propellors (hereinafter, “turbo-prop”) in the case of some airplanes. In alternate embodiments, the propulsor may drive one or more turbo-propellers, embodied as rotors, for operation of a helicopter.

During operation, significant heat is generated by the combustion and energy extraction processes with gas turbine engines. It is necessary to manage heat generation within the engine so as not raise engine temperatures to unacceptable levels, which may cause engine failure. One method of controlling heat and improving engine life is to lubricate engine components and cool lubricating fluids. Heat exchangers utilizing fans in a by-pass duct are used according to some embodiments. However, powering of such fans and the need for a by-pass duct add size, structure and weight to the gas turbine engine.

In order to improve efficiency of gas turbine engine aircraft, a continuing goal is to reduce weight and provide cost savings associated with fan, fan motors, drive shafts and ducting. Additionally, this will result in lower fuel and operating costs.

It would be desirable to overcome these and other deficiencies and maintain or improve cooling while reducing weight of an aircraft engine.

### SUMMARY

According to present embodiments, a conformal surface heat exchanger is provided. The heat exchanger conforms to the surface of an aircraft, such as an airplane or helicopter. The heat exchanger is positioned in the airflow path of the turbo-prop of the aircraft to provide fluid-to-air heat exchange and cooling of engine fluid while improving engine performance.

According to some embodiments, a method for assembling a turbine engine to facilitate reducing operating temperature of a fluid utilized therein, the turbine engine turning a turbo-prop assembly of an aircraft comprises providing a liquid-to-air heat exchanger that includes a plurality of channels extending therethrough, a plurality of cooling fins coupled to each of the plurality of channels and configured to receive a flow of air from the turbo-prop assembly to facilitate reducing a temperature of a liquid flowing through the channels, at least one attachment structure associated with the heat exchanger, at least one plate coupled to the heat exchanger to facilitate directing airflow over the plurality of cooling fins, conforming the heat exchanger for positioning along an external surface of an aircraft by approximating contours of the external surface with a profile of the heat exchanger, coupling the heat exchanger along an external surface of the aircraft for cooling by use of airflow from the turbo-prop assembly. The aircraft may be an airplane or a helicopter. The conforming may comprise bending the heat exchanger. The turbo-prop assembly may comprise an airplane propeller or a helicopter rotor. The method may further comprise positioning the heat exchanger along a flowpath of the turbo-prop assembly.

### BRIEF DESCRIPTION OF THE ILLUSTRATIONS

The above-mentioned and other features and advantages of these exemplary embodiments, and the manner of attaining them, will become more apparent and the conformal surface heat exchanger for aircraft will be better understood by reference to the following description of embodiments taken in conjunction with the accompanying drawings, wherein:

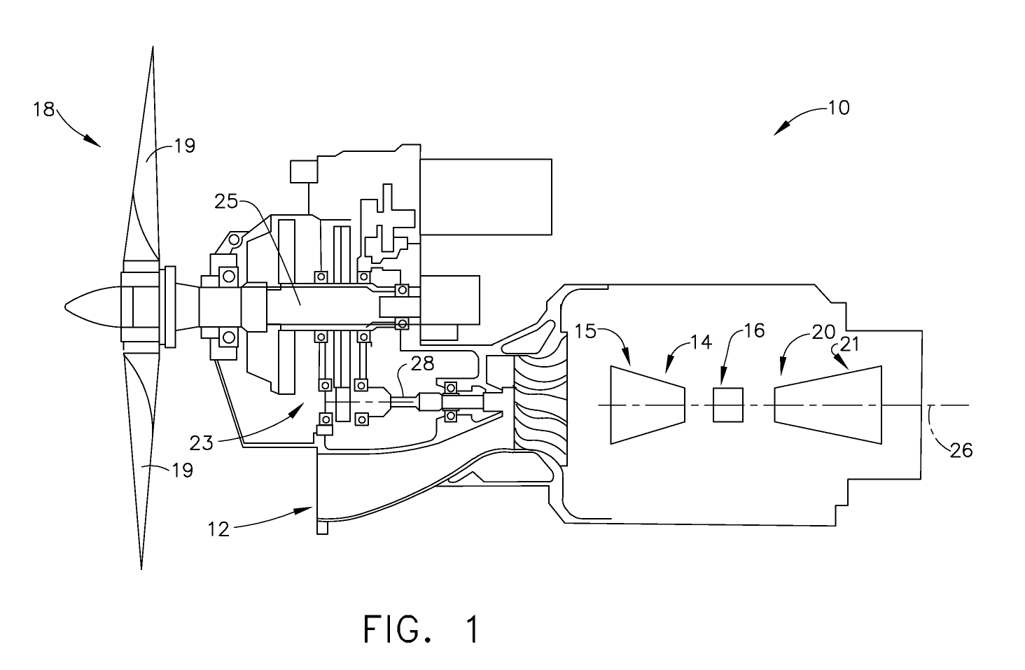

FIG. 1 is a side section view of gas turbine engine for turbo-prop aircraft;

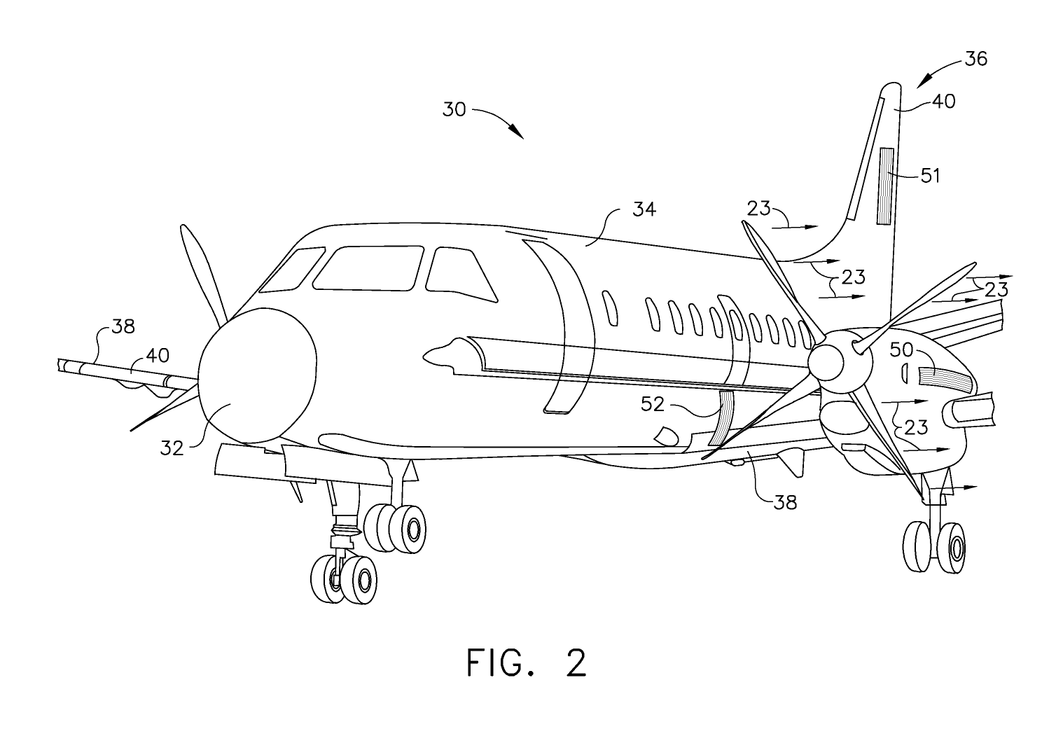

FIG. 2 is a isometric view of an exemplary turbo-prop airplane;

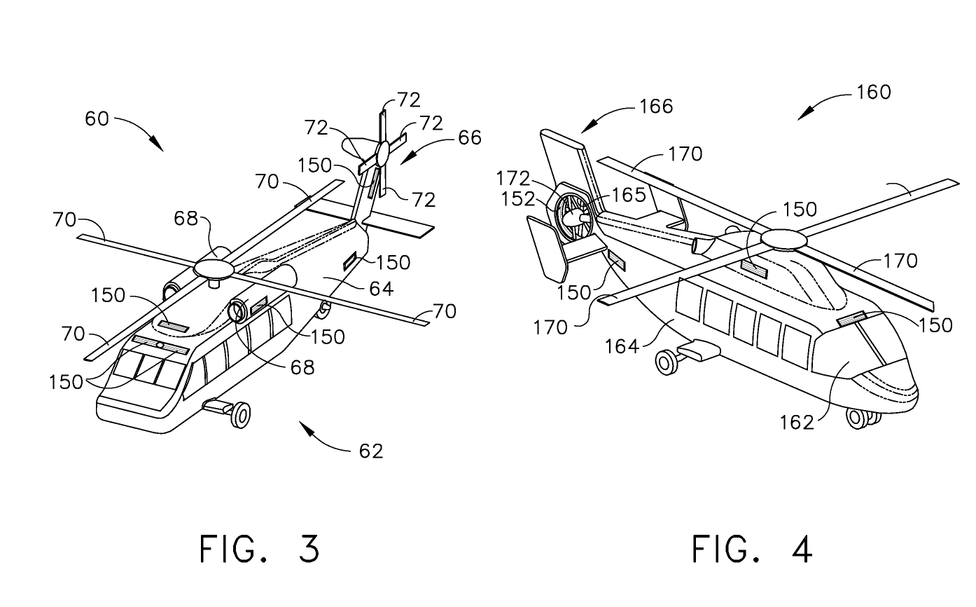

FIG. 3 is an isometric view of one exemplary helicopter;

FIG. 4 is an isometric view of a second exemplary helicopter;

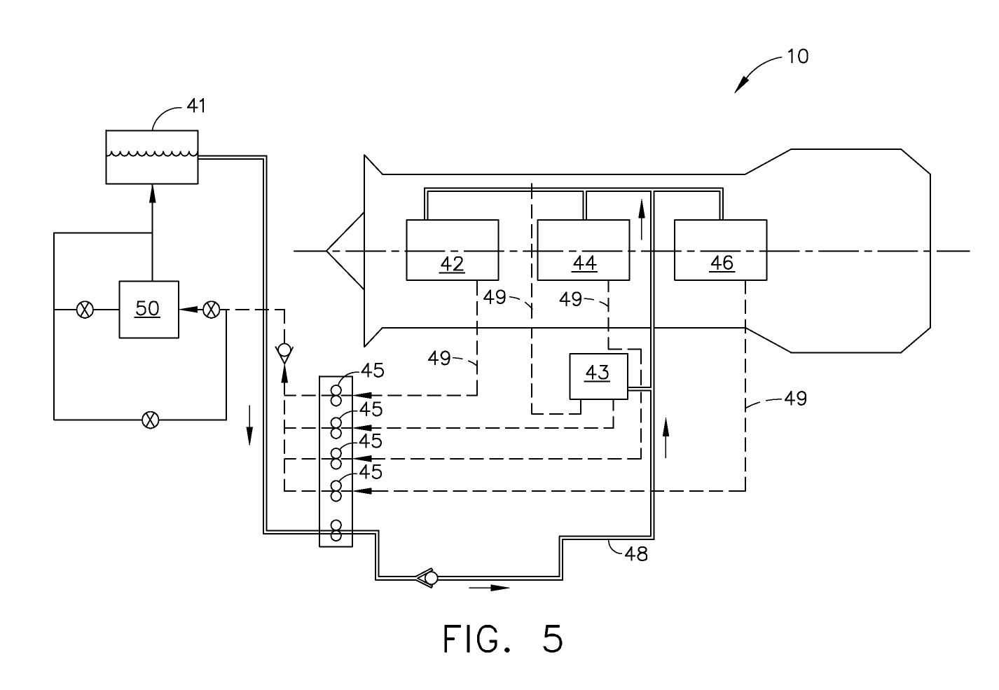

FIG. 5 is an exemplary schematic diagram of a fluid cooling circuit for the conformal heat exchanger;

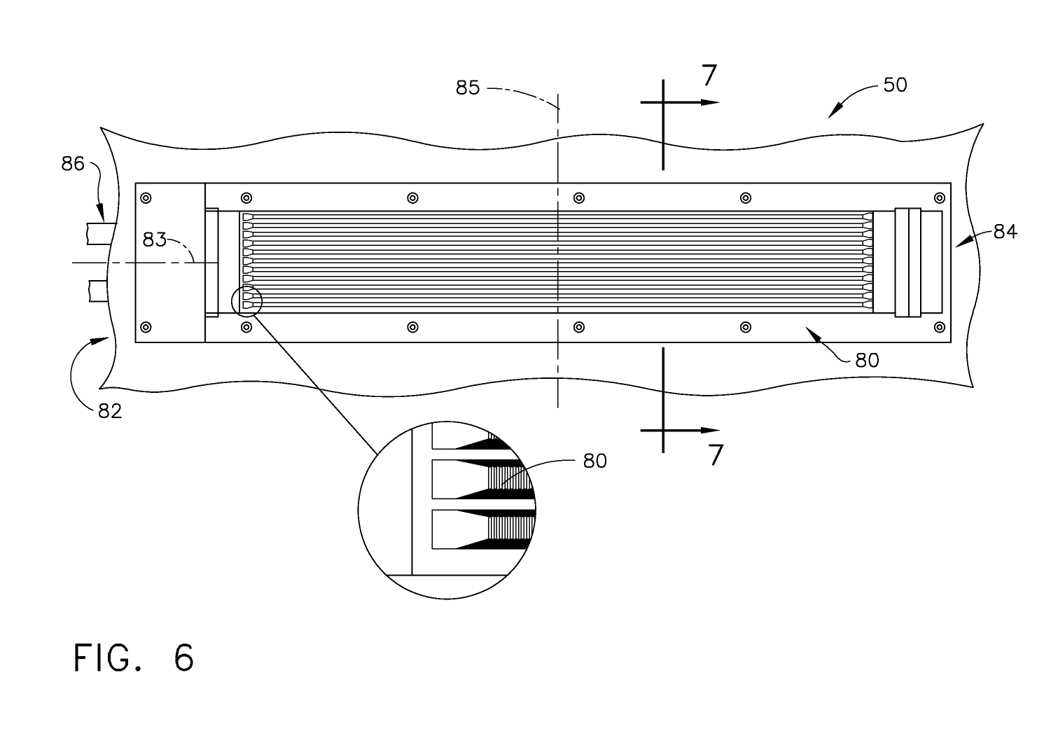

FIG. 6 is a top view of an exemplary conformal heat exchanger;

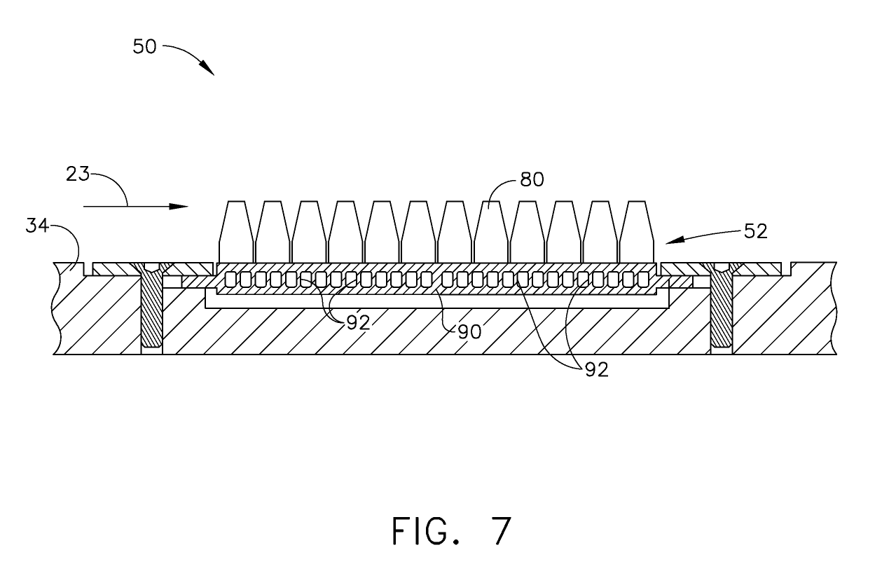

FIG. 7 is a cross-sectional view of the heat exchanger of FIG. 6; and,

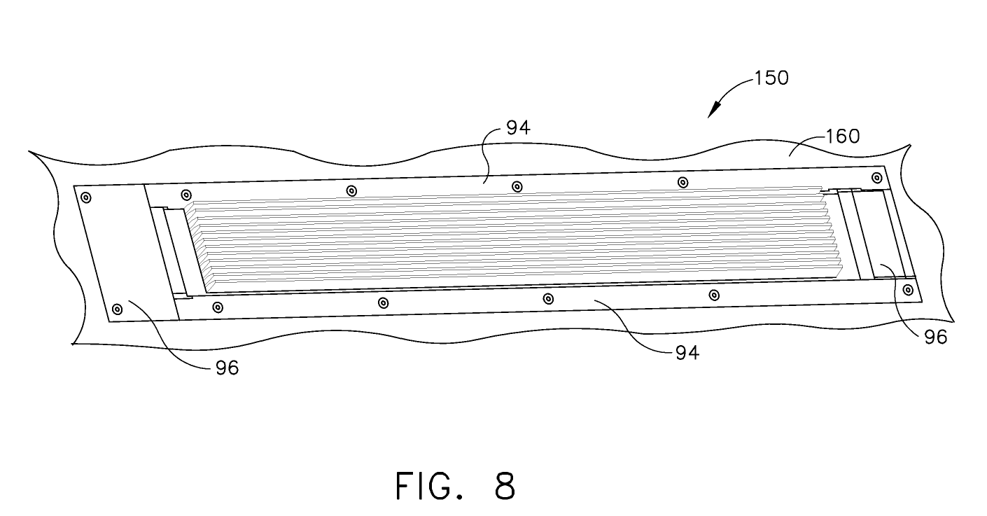

FIG. 8 is an isometric view of the heat exchanger on an exemplary helicopter of FIG. 4.

### DETAILED DESCRIPTION

Reference now will be made in detail to embodiments provided, one or more examples of which are illustrated in the drawings. Each example is provided by way of explanation, not limitation of the disclosed embodiments. In fact, it will be apparent to those skilled in the art that various modifications and variations can be made in the present embodiments without departing from the scope or spirit of the disclosure. For instance, features illustrated or described as part of one embodiment can be used with another embodiment to still yield further embodiments. Thus it is intended that the present invention covers such modifications and variations as come within the scope of the appended claims and their equivalents.

Referring to FIGS. 1-8, various embodiments of the conformal heat exchanger for aircraft are depicted. The heat exchanger is formed to conform to the shape of an external surface of an aircraft, such as airplane or helicopter, and located along a flowpath created by a turbo-prop assembly, such as on an airplane or a helicopter. This eliminates the need for additional engine architecture associated with current cooling configurations. These examples however are not limiting and other embodiments may be utilized.

As used herein, the terms “axial” or “axially” refer to a dimension along a longitudinal axis of an engine. The term “forward” used in conjunction with “axial” or “axially” refers to moving in a direction toward the engine inlet, or a component being relatively closer to the engine inlet as compared to another component. The term “aft” used in conjunction with “axial” or “axially” refers to moving in a direction toward the engine outlet, or a component being relatively closer to the engine outlet as compared to an inlet.

As used herein, the terms “radial” or “radially” refer to a dimension extending between a center longitudinal axis of the engine and an outer engine circumference. The use of the terms “proximal” or “proximally,” either by themselves or in conjunction with the terms “radial” or “radially,” refers to moving in a direction toward the center longitudinal axis, or a component being relatively closer to the center longitudinal axis as compared to another component. The use of the terms “distal” or “distally,” either by themselves or in conjunction with the terms “radial” or “radially,” refers to moving in a direction toward the outer engine circumference, or a component being relatively closer to the outer engine circumference as compared to another component.

As used herein, the terms “lateral” or “laterally” refer to a dimension that is perpendicular to both the axial and radial dimensions.

Referring initially to FIG. 1, a schematic side section view of a gas turbine engine 10 is shown having an engine inlet end 12 wherein air enters a propulsor 13, which is defined generally by a multi-stage compressor, including for example a low pressure compressor 15 and a high pressure compressor 14, a combustor 16 and a multi-stage turbine, including for example a high pressure turbine 20 and a low pressure turbine 21. Collectively, the propulsor 13 provides power during operation to drive a turbo-prop assembly. The gas turbine 10 is axis-symmetrical about engine axis 26 so that various engine components rotate thereabout. In operation air enters through the air inlet end 12 of the engine 10 and moves through at least one stage of compression where the air pressure is increased and directed to the combustor 16. The compressed air is mixed with fuel and burned providing the hot combustion gas which exits the combustor 16 toward the high pressure turbine 20. At the high pressure turbine 20, energy is extracted from the hot combustion gas causing rotation of turbine blades which in turn cause rotation of the high pressure turbine shaft. The high pressure turbine shaft passes toward the front of the engine to continue rotation of one or more high pressure compressor stages 14.

The engine 10 includes at least a second shaft 28. The second shaft 28 extends between the low pressure turbine 21 and a low pressure compressor 15, and rotates about the centerline axis 26 of the engine.

Referring still to FIG. 1, the inlet 12 includes a turbo propeller (“turbo-prop”) 18 which includes a circumferential array of exemplary blades 19 extending radially outward from nose cone. The turbo propeller 18 is operably connected by the shaft 25, gear box or other transmission 23 to the shaft 28 and low pressure turbine 21 to create thrust for the turbine engine 10. The term turbo-prop or turbo-propeller is meant to include both propellers for airplanes and rotors for helicopters.

Referring now to FIG. 2, an isometric view of an exemplary aircraft, for example an airplane 30, is shown. The airplane is generally referred to as a turbo-prop airplane. The plane 30 includes a nose 32 and a fuselage 34 extending between the nose and the tail section 36. At least one wing 38 extends laterally from the fuselage 34. According to the instant embodiments, the wing 38 may extend as a single structure bisected by the fuselage 34 or may be two separate wing structures extending from the fuselage 34. Additionally, the wing may be mounted below the fuselage as depicted or above the fuselage as common with some airplanes. The at least one wing 38 and tail section 36 comprise control surfaces 40 which are utilized to control flight of the aircraft 30.

The at least one wing 38 includes gas turbine engines 10 on either side of the fuselage 34. According to other embodiments, the engine and propeller assembly may be at the forward or the rearward end of the plane. The gas turbine engines 10 have turbo-props 18 including multiple blades 19 which create thrust for the airplane 30. As the turbo-prop assembly 18 rotates, an airflow path 23 is created extending aft along the airplane 30. The airflow path 23 necessarily causes thrust for the airplane and lift as air passes over the at least one wing 38. The airplane 30 also comprises at least one conformal surface heat exchanger 50. The instant embodiment includes the heat exchanger 50 on a laterally outer surface of the engine housing. However, the heat exchanger 50 may be disposed on any surface of the engine wherein the conformal surface heat exchanger 50 is disposed within the airflow path 23. This allows that heat of engine fluid is removed through the heat exchanger 50 during flight and during stationary engine operation, for example on a tarmac or in a holding pattern on a runway. A second heat exchanger 52 is depicted along the fuselage 34. This is because airflow path 23 from the turbo-prop 18 also moves along the fuselage 34. Similarly, the heat exchangers 50, 52 may be located at various surfaces of the airplane 30 where airflow path 23 moves or where airflow during normal flight may also aiding in cooling of engine fluids. The heat exchangers 50, 52 may be oriented in different directions. For example, in some instanced it may be desirable to orient the exchanger in a long axis vertical orientation such as shown with heat exchanger 51, while in other instances it may be desirable to orient the exchanger in a long axis horizontal orientation such as 50. Alternatively, a heat exchanger may be position on curved surfaces such as shown with heat exchanger 52. Moreover, the airplane 30 may include various numbers of heat exchangers 50. Further, while a turbo-prop airplane is depicted, the depicted embodiments are also capable of use with a jet aircraft where engine thrust air exiting the engine may pass over the heat exchangers 50, 51, 52. While the heat exchange may not be as good due to higher temperatures of the engine exhaust, the available heat exchange may be enough for engine fluid cooling.

Referring now to FIG. 3, a second exemplary turbo-prop aircraft is depicted. In this embodiment the turbo-prop aircraft is a helicopter 60 and the turbo-prop assembly defines at least one rotor assembly. The helicopter 60 includes a cabin portion 62 defined by a fuselage 64 which extends aft to a tail section 66. The top surface of the helicopter fuselage 64 includes at least one gas turbine engine 68. According the exemplary embodiment, two gas turbine engines are positioned on the upper side of the fuselage 64 above the cabin 62. The gas turbine engines 68 operate a main or primary rotor assembly 70, which is a form of a turbo-prop. Additionally, at the tail section 66 is a secondary rotor assembly 72. Each of these primary and secondary rotors 70, 72 produces an airflow path as with the airplane of the previous embodiment. In the case of the primary rotors 70, the airflow path is generally downward causing the rotor wash to push the helicopter 60 upward into flight. This downward flow also allows for cooling of appropriately positioned heat exchangers 150. The secondary rotors 72 counter the tendency of the helicopter fuselage 64 due to the rotation of the rotors 70. Thus, the airflow path created by the secondary rotor is generally horizontal in nature.

A plurality of heat exchangers 150 are located along the fuselage 64, tail section 66 and housings of the gas turbine engines 68. All of these heat exchangers are placed such that the airflow paths of the rotors 70, 72 move across the heat exchangers 150 resulting in cooling of engine fluids passing through the heat exchangers. Additionally, in the application of these heat exchangers to a helicopter, since the rotors 70, 72 rotate when the gas turbine engines 68 are operating, regardless of whether the helicopter 60 is in flight, the heat exchangers 150 are continuously cooling engine fluids.

Referring now to FIG. 4, a second embodiment of a helicopter 160 is depicted. In this secondary embodiment, the helicopter 160 includes a fuselage 164 having a forward cabin 162 and a tail section 166. The heat exchangers 150 are located again in areas where the rotor wash causes an air flow to move across the heat exchanger thus cooling engine fluid passing through the exchangers 150. In the instant embodiment, a heat exchanger 152 is utilized in the tail section 166 and differs from the previous embodiment. According to the instant embodiment, a duct 165 is created wherein the secondary rotor 172 can rotate. The duct 165 is generally circular in shape and has a width in a horizontal direction creating a space wherein the heat exchanger 152 may be disposed spaced from the radially outer edges of the rotors 172. Again, as with previous embodiments, the heat exchangers 150, 152 are conformal meaning the shape may be varied to approximate contours located along the outer surface of the helicopters 60, 160 or in the previous embodiment of the airplane. The heat exchangers 150 may be located near the cabin 162, along an upper surface of the fuselage 164, near the engine casing and closer to the tail section 166. These locations are generally selected as they will be washed with rotor airflow during operation of the helicopter 160. Additionally, as with the previous embodiment, the rotor wash cools the heat exchangers 150 regardless of whether the helicopter 160 is in flight or merely operating on a tarmac or landing pad.

These heat exchangers 150 may be flat or contoured about one or more axes so as to match the contours in the installation location. Additionally, the structures may be circumferential. The heat exchangers 50, 150, 152 may be formed of a one-piece manifold structure having a plurality of integrally cooling fins extending outwardly from the heat exchanger so as to allow for engagement of the fins by the airflow path created from the turbo-props of the helicopters 60, 160 and the airplane 30. Alternatively, the exchangers may be formed of separate manifold and fin structures which are joined to define a one piece segment or a multiple segments.

Referring now to FIG. 5, a schematic view of the cooling circuit and engine is depicted. The engine 10 is shown schematically and includes various bearings 42, 44, 46 for example, which are supplied engine fluid for cooling through pathways 48 extending between a reservoir 41 and the bearings 42, 44, 46. Fluid may also be supplied to a gear box 43. A plurality of fluid return lines 49 are shown in broken line, which remove heat from the bearings 42, 44, 46 and optionally the gear box 43, and pass through pumps 45 to the heat exchanger 50, for example. Within the heat exchanger 50, cooling of the engine fluid occurs as the propeller washes airflow over the exchangers 50 and the fluid subsequently returns to the reservoir 41. Various valves are shown schematically through the simplified diagram to depict that various valving arrangements may be utilized, however, these configurations are non-limiting and merely examples of one embodiment. Additionally, although the schematic view depicts heat exchanger 50, any of the heat exchangers defined previously, such as heat exchanger 50, 52, 150, 152 or other embodiments may be substituted in the schematic for the embodiment depicted.

Referring now to FIG. 6, a top view of a conformal surface heat exchanger 50 is depicted. The heat exchanger 50 is generally linear having a plurality of fins 80 extending between a first end 82 and a second end 84 of the heat exchanger 50. The fins 80 are very thin as shown in the detail window, so as to appear like a solid linearly extending structure as shown in the primary view of the figure. Extending between the first end 82 and the second end 84, behind the fins 80 is the core having one or more passages for engine fluid to move through the heat exchanger 50. The exchanger further comprises first and second couplings 86 for inputting and outputting engine fluid passing through the heat exchanger 50. In the instant embodiments, the heat exchanger 50 is placed with the fins 80 facing outwardly from the surface of the aircraft so that the turbo-prop washes air over these fins 80 providing cooling to the fluid passing through the exchanger 50. Additionally, since the structure is generally formed of a single metallic structure, the piece may be formed or bent about various axes of the structure to correspond or conform to a surface of the aircraft wherein the heat exchanger will be positioned. The axes 83, 85 are shown as exemplary axes about which the structure may be bent. Additionally, in order to form the heat exchanger 152 (FIG. 4), the heat exchanger may be bent about an axis which is spaced from the heat exchanger. Additionally, according to some embodiments, the segment depicted may be joined with various segments in order to form an elongate structure and provide additional cooling. This will be designed dependent upon the cooling capacity needed.

Referring now to FIG. 7, a cross-sectional view of the embodiment of FIG. 6 is depicted. The heat exchanger 50 is shown positioned within a fuselage 34 so that the fins 80 are extending through an aperture in the fuselage 34. The heat exchanger includes a core 90 having a plurality of apertures 92 extending through the core 90. A plurality of heat exchange fins 80 are positioned extending from the core 90 and through the fuselage 34. Various retaining structures may be utilized to retain the core 90 within the aperture of the fuselage 34. The apertures 90 allow fluid flow therethrough while airflow path 23 flows through the fins 80 to remove heat from the fluid passing through the apertures 92 of the core 90. Additional structure may be utilized around the core 90 to protect the core along the interior side of the heat exchanger 50 as well as for connection of the entire structure to the aircraft. The cooling fins 80 extend in a direction that is perpendicular to the long axis of the heat exchanger 50. However, such arrangement is not mandatory or limiting and the arrangement of fins may affect the orientation of the heat exchanger 50 on the aircraft. The cooling fins 80 are aligned in at least one direction to allow for the airflow 23 to move therethrough. According to the embodiment depicted, the fins 80 may be aligned in two transverse directions allowing improved air flow, for example into and out of the page or as shown by airflow 23. The fins 80 define a plurality of channels or rows extending in, according to the instant embodiment, two directions. The fins 80 may be formed with the core of a single piece or structure or may be welded or brazed onto the core 90. According to instant embodiments, aluminum may be utilized to form the heat exchanger core 90 and fins 80. However, this is non-limiting as various metallic structures may be utilized with suitable heat transfer qualities to remove heat from fluid passing through the fluid flowpaths, channels or holes 92.

Referring to FIG. 8, an exemplary mounting position is depicted in the exemplary helicopter 160, for example above a cockpit windshield. The heat exchanger 150 is mounted with flanges 94 extending between first and second ends 82, 84. The heat exchanger 150 may further comprise end or manifold flanges 96 or may be connected through the manifolds to aid with mounting the heat exchanger 150. The flanges 94, 96 are fastened to the aircraft in the instant embodiment, however various methods and means may be utilized to couple the exchangers to the aircraft. It is desirable to not impede airflow over the aircraft. From between the flanges 94, 96 the heat exchange fins 80 extend outwardly from the surface of the helicopter 160. The fluid couplings 86 are located on the inside of the heat exchanger 150 and are connected to fluid tubing extending from the turbine engine 10 for fluid communication.

The foregoing description of structures and methods has been presented for purposes of illustration. It is not intended to be exhaustive or to limit the invention to the precise steps and/or forms disclosed, and obviously many modifications and variations are possible in light of the above teaching. Features described herein may be combined in any combination. Steps of a method described herein may be performed in any sequence that is physically possible. It is understood that while certain embodiments of methods and materials have been illustrated and described, it is not limited thereto and instead will only be limited by the claims, appended hereto.

What is claimed is:

1. A method for assembling a turbine engine to facilitate reducing operating temperature of a fluid utilized therein, said turbine engine turning a turbo-prop assembly of an aircraft comprising:
providing a liquid-to-air heat exchanger that includes:
a core;
a plurality of channels extending through said core;
a plurality of cooling fins coupled to each of said plurality of channels and configured to receive a flow of air from said turbo-prop assembly to facilitate reducing a temperature of a liquid flowing through said channels;
at least one coupling structure associated with said heat exchanger;
at least one flange coupled to the heat exchanger to facilitate directing airflow over said plurality of cooling fins;
conforming said heat exchanger for positioning along a surface of an aircraft by approximating contours of said surface with a profile of said heat exchanger;
coupling said heat exchanger along an external surface of said aircraft for cooling by use of airflow from said turbo-prop assembly.

2. The method of claim 1 wherein said aircraft is an airplane.

3. The method of claim 1 wherein said aircraft is a helicopter.

4. The method of claim 1 wherein said conforming comprises bending said heat exchanger.

5. The method of claim 1 wherein said turbo-prop assembly includes an airplane propeller 18 or a helicopter rotor.

6. The method of claim 1 further comprising positioning said heat exchanger along said flow of air from said turbo-prop assembly.

7. The method of claim 1, wherein said positioning is external along said aircraft.

8. The method of claim 1, wherein said positioning is internal within a duct of said aircraft.

9. The method of claim 1, wherein said flow of air is created by said turbo-prop assembly.

10. The method of claim 1, wherein said flow of air is created by movement of said aircraft.

11. The method of claim 1, said channels extending substantially perpendicular to said flow of air.

12. The method of claim 1, said channels extending substantially parallel to said flow of air.
